(19) United States
(12) Patent Application Publication
(10) Pub. No.: US 2025/0060797 A1
(43) Pub. Date: Feb. 20, 2025

(54) REMOTE COMMUNICATIONS SYSTEM DISTRIBUTION MODULE AND METHOD

(71) Applicant: GBA SYSTEMS INTEGRATORS, LLC, Lenexa, KS (US)

(72) Inventor: James L. GILBERT, Eudora, KS (US)

(21) Appl. No.: 18/722,367

(22) PCT Filed: Dec. 21, 2022
(86) PCT No.: PCT/US2022/082121

§ 371 Date: Jun. 20, 2024

Related U.S. Application Data
(60) Provisional application No. 63/292,283, filed on Dec. 21, 2021.

(51) Int. Cl. G06F 1/16; H04W 72/0453; H04W 84/18

(52) U.S. Cl. CPC G06F 1/1698; H04W 72/0453; H04W 84/18

(57) ABSTRACT

A distribution module (DM) device comprising a rigid, protective case having a hollow interior, a single-board computer (SBC) mounted within the rigid case, a first radio, and one or more other radios. The first radio serves as an internet access point and is communicably coupled within the rigid case to the SBC. The one or more other radios have meshing capabilities and are communicably coupled within the rigid case to the SBC. The first radio can operate at about 900 MHz, 2.4 GHz or 5 GHz bandwidth and functions as a local access point for Wi-Fi-enabled devices. The one or more other radios each operate at about a 2.4 GHz, 5 GHz, or 6 GHz bandwidth and communicably couple with other DM devices to form a mesh network. Multiple DM devices can be monitored and updated remotely and used in a system for mesh networking communication in remote locations.

### CROSS-REFERENCE TO RELATED APPLICATIONS

The present application claims the priority benefit of U.S. Provisional Patent Application No. 63/292,283 filed on Dec. 21, 2021, entitled “Remote Communication System Distribution Module and Method,” which is incorporated by reference herein in its entirety.

### FIELD OF THE INVENTION

The present disclosure relates to a long-range distribution module for internet access and other communication systems.

### BACKGROUND

Installation and operation of communications systems in remote and austere environments present a number of unique challenges. However, it is desirable for users/organizations to quickly establish internet access and VoIP communications from any fixed or stationary location on earth. Known remotely deployable communications systems are typically limited concerning power sourcing, ease of setup and use, scalability, portability, and/or network connectivity. Accordingly, the known available communications systems all have shortcomings because of inherent design limitations and/or failure to incorporate the entire feature set of the present invention within a single, portable device. Wi-fi hotspots, routers, and switches in other such prior art communications devices lack desired versatility and customizability and also have limited capabilities to communicate with and/or manage or drive other devices.

### SUMMARY

A distribution module (DM) device is described herein. A distribution module (DM) device comprising having a rigid, protective case having a hollow interior, a single-board computer (SBC) mounted within the rigid case, a first radio, and one or more other radios (e.g., a second radio, a third radio, and/or a fourth radio). The first radio serves as an internet access point and is communicably coupled within the rigid case to the SBC. The one or more other radios with meshing capabilities are communicably coupled within the rigid case to the SBC. The first radio can operate at about a 900 MHz, a 2.4 GHz, or a 5 GHz bandwidth and functions as a local access point for Wi-Fi-enabled devices. The one or more other radios can each operate at about a 2.4 GHz, 5 GHz, or 6 GHz bandwidths. Multiple DM devices can be monitored and updated remotely and used in a system for mesh networking communication in remote locations.

In another embodiment, a system for mesh networking communication in remote locations includes two or more of the DM devices such as the DM device described above, with second, third radios, and/or forth radios each operating at a higher bandwidth than the first radio. The system may also include a computing device communicably coupled with the two or more DM devices. Furthermore, the computing device may have a computer program operating thereon that is configured for management of the SBC and/or updating the SBC of any of the two or more DM devices.

In some embodiments, for any of the DM devices described herein, the DM device can additionally include a plurality of ports extending through the rigid case and a plurality of antennae. The ports may be electrically and/or communicatively coupled with one or more of the SBC, the first radio, the second radio, and the third radio. The plurality of antennae may each be coupled to at least one of the plurality of ports. For example, the antennae may include a flat panel antenna or an omni antenna. Furthermore, the case of any of the DM devices described herein can be at least twice a total area or a total volume of the SBC and the radios described herein to provide space for additional components if or when updates are required for the DM device.

This summary is intended to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the current disclosure are described in detail below with reference to the attached drawing figures, wherein:

FIG. 1 is an internal schematic view of a distribution module (DM) device according to embodiments of the present invention;

FIG. 2 is a top external plan view of a case of the DM device of FIG. 1 according to embodiments of the present invention;

FIG. 3 is a bottom external plan view of the case of FIG. 2 according to embodiments of the present invention;

FIG. 4 is a block diagram of example operational components of the DM device of FIG. 1, depicting details of a single-board computer (SBC) of the DM device and external connections made therewith according to embodiments of the present invention;

FIG. 5 illustrates an example performance table associated with exemplary radios of FIG. 1 according to embodiments of the present invention;

FIG. 6 is a side view of the DM device of FIG. 1, depicting ports thereof according to embodiments of the present invention;

FIG. 7 is a side view of an omni antenna couplable to the DM device of FIG. 1 according to embodiments of the present invention;

FIG. 8 is a top view of a flat panel antenna couplable to the DM device of FIG. 1 according to embodiments of the present invention;

FIG. 9 is a top view of a cable for connecting the flat panel antenna of FIG. 8 to the DM device of FIG. 1 according to embodiments of the present invention;

FIG. 10 is an exemplary screen capture of a login screen of a management software interface associated with the DM device of FIG. 1 according to embodiments of the present invention;

FIG. 11 is an exemplary screen capture of an overview screen of the management software interface associated with the DM device of FIG. 1 according to embodiments of the present invention;

FIG. 12 is an exemplary screen capture of the overview screen of FIG. 11 with expanded menu options as a result of a user selecting a user-selectable option identified here as “Network,” according to embodiments of the present invention;

FIG. 13 is an exemplary screen capture of a pop-up window associated with the management software interface when the user selects a user-selectable option identified in FIG. 12 as “Wireless,” according to embodiments of the present invention;

FIG. 14 is an exemplary screen capture of the pop-up window of FIG. 13 with specific user-selectable options identified according to embodiments of the present invention;

FIG. 15 is an exemplary screen capture of another pop-up window appearing as a result of the user selecting a user-selectable option identified in FIG. 14 as “edit” for editing settings for one of the radios of the DM device in FIG. 1 according to embodiments of the present invention;

FIG. 16 is an exemplary screen capture depicting a user-selectable button for saving edits made in the pop-up window of FIG. 15, according to embodiments of the present invention;

FIG. 17 is an exemplary screen capture of yet another pop-up window appearing as a result of the user selecting a user-selectable option in FIG. 14 for editing another one of the radios of the DM device in FIG. 1, according to embodiments of the present invention; and

FIG. 18 is an exemplary screen capture of still another pop-up window appearing as a result of the user selecting a user-selectable option in FIG. 14 for editing yet another one of the radios of the DM device in FIG. 1, according to embodiments of the present invention.

The drawing figures do not limit the current invention to the specific embodiments disclosed and described herein. While the drawings do not necessarily provide exact dimensions or tolerances for the illustrated components or structures, the drawings are to scale as examples of certain embodiments with respect to the relationships between the components of the structures illustrated in the drawings.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Various advantages of the embodiments of the invention described herein will be apparent to those skilled in the art upon review of the disclosure and Figures herein and the detailed discussion below. It will be appreciated that the various embodiments described herein are not necessarily mutually exclusive unless otherwise indicated herein. For example, a feature or configuration of components described or depicted in one embodiment may also be included in other embodiments but is not necessarily included.

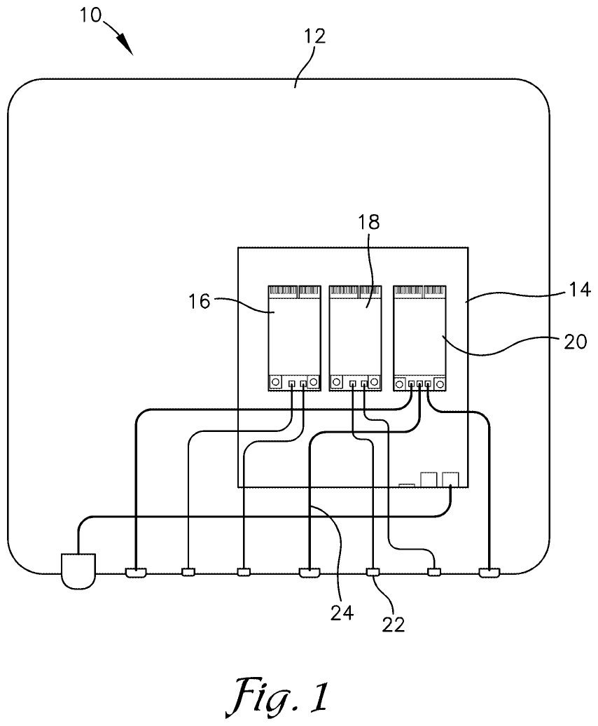

A distribution module (DM) device 10, as depicted in FIG. 1 and described herein, can be an industrial grade router with various customization options and includes open-source software customized to allow the device to meet various user needs. For example, the DM device can serve as a high-power, ruggedized meshing outdoor access point for the connection and extension of existing internet services. The DM device has a much longer range than most routers known in the art. That is, a single DM device can have a range of 900 to 1100 feet, although other ranges can be used without departing from the technology described herein. In some embodiments, a plurality of DM devices can be used as modern AI-managed meshed field nodes, configurable to end-users needs and specifications. The DM device can be a plug and play device including a rigid case having a hollow interior, a single-board computer mounted within the rigid case, and a plurality of radios. Specifically, the radios can include a first radio configured to serve as an internet access point and communicably coupled within the rigid case to the single-board computer, a second radio with meshing capabilities and communicably coupled within the rigid case to the single-board computer, a third radio with meshing capabilities and communicably coupled within the rigid case to the single-board computer, and/or a fourth radio with meshing capabilities and communicably coupled within the rigid case to the single-board computer. However, the DM device 10 can be reconfigurable with slots or connections on the single-board computer for communicably coupling various combinations of one through four radios thereto within the DM device 10.

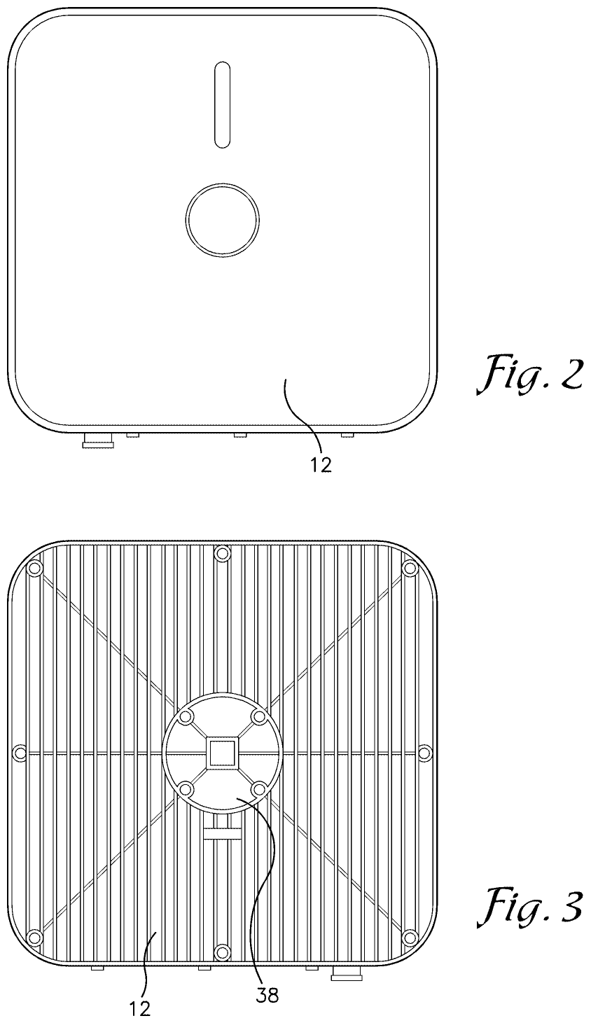

In various embodiments described herein, as depicted in FIGS. 1-4 and 6, the DM device 10 includes a rugged, water-proof case 12 housing a single-board computer (SBC) 14 and separate radios 16, 18,20 that are not integrated into a router board. For example, in some embodiments, the radios 16-20 can be identified as Radio 0, Radio 1, and Radio 2. A simplified example RDM21 schematic is depicted in FIG. 1 with the case 12, the SBC 14, the radios 16-20, as well as a plurality of input and output ports 22 and various cables 24 configured for electrical and/or communication signals to be delivered therein.

In some embodiments, the DM device 10 is intended for permanent installation at least five meters above the ground and is not a portable device, while in other embodiments the DM device 10 is a portable device. In one example embodiment, the DM device radios 16-20 include one 2.4 GHz radio (e.g., having a large area of coverage for wi-fi signal, such as 1,000-foot radius) and two 5.0 GHz radios for meshing purposes between other similar or identical ones of the DM device 10. Using this example embodiment, each of a plurality of DM devices can be meshed together, so a first DM device can be connected to a second DM device a distance away (e.g., 1000 feet away). DM devices as described herein can advantageously include optimum hardware, antennas having higher-gain and higher-strength, and can utilize open-source software to create a more powerful system.

Returning to FIGS. 1-3, the case 12 can be designed of any rigid material suitable for rugged outdoor use. For example, the case 12 can be an IP67 enclosure configured to protect electronics therein from dust, moisture, and even temporary immersion. In some embodiments, the case 12 is designed with extra volume internally, beyond what is required for the plurality of radios 16-20 and the SBC 14 described herein, such that the case can have secondary components added therein for specific customer needs, such as non-radio-specific needs (e.g., edge computing, edge data storage, etc.). For example, if a user needs the DM device 10 to additionally store photographs recorded instead of constantly transmitting them, additional storage can be added to the DM device 10 to allow for this example use case. The radios 16-20 of the DM device 10 can also be changed to be mission-specific per user needs by hardware adjustments and/or management software-controlled adjustments as described below. The extra volume of the case 12, as well as the software platform described herein, gives the DM device 10 more capabilities than a traditional wi-fi distribution module, allowing it to use virtually any combination of radios for a variety of user needs. In some embodiments, the area within the case 12 is at least one-and-a-have times or at least twice a total area or a total volume of the SBC and the radios described herein. However, other smaller or larger dimensions can be used for the case 12 without departing from the scope of the technology described herein. The casing 12 or exterior housings depicted herein are merely exemplary. Other shapes and sizes of the casing 12 and/or other such exterior housing components can be used without departing from the scope of the technology described herein. In some embodiments, the case 12 may also include and/or be configured for attachment via an enclosure mount 38. The enclosure mount 38 can be, for example, an adjustable fiberglass mounting bracket. Some embodiments of the case 12 include a plurality of slots or protrusions framing out individual compartments for anywhere from one, two, three, or four radios to be individually retained thereby when coupled to the SBC 14.

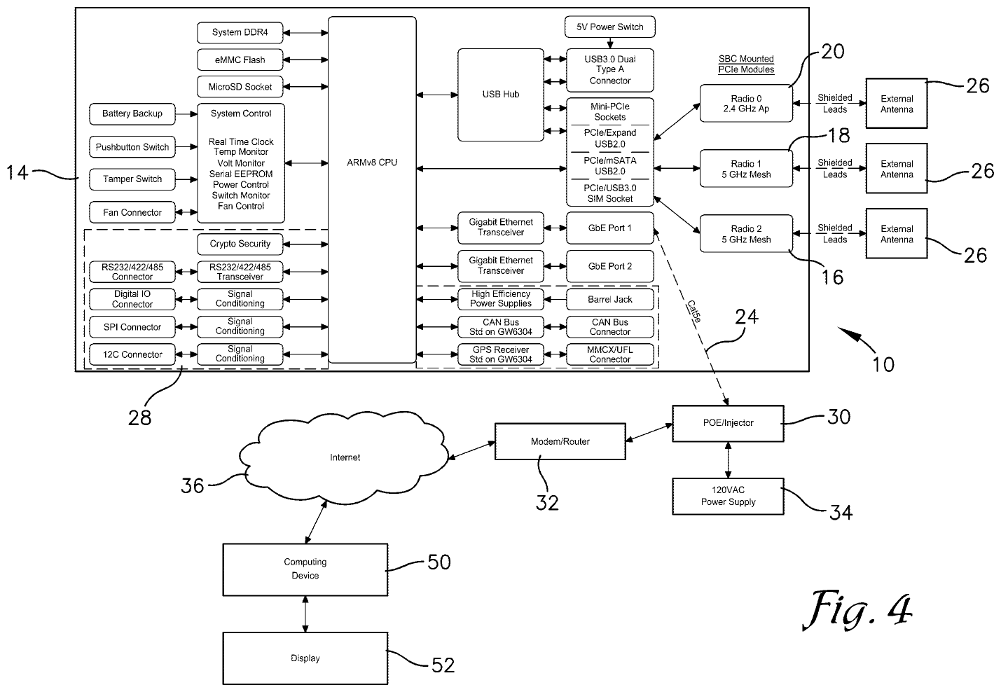

FIG. 4 depicts an example block diagram of the DM device 10 with the SBC 14, the radios 16-20, example antennas 26 to connected with the radios external of the case 12, and other external and internal operation components and features electrically and/or communicably coupled via the various cables 24 and/or wireless communication devices. FIG. 4 also depicts one of the cables 24, such as a Cat5e cable, being coupled to a Power over Ethernet (POE) Injector 30, which is likewise communicably coupled with a modem/router 32 and a power supply 34 (e.g., a 120 VAC power supply). The modem/router 32 is likewise communicably coupled to Internet 36 via wired or wireless connections. Furthermore, FIG. 4 depicts additional computer board unutilized functionalities 28 that may be available but not utilized in some embodiments herein. This may allow for future upgrades or updates, even if not used in an initially-installed embodiment of the DM device 10.

As used herein, the single-board computer (e.g., SBC 14) is a complete computer built on a single circuit board, with microprocessor(s), memory, input/output (I/O) and other features required of a functional computer. That is, in some embodiments, the SBC 14 allows integration of all required computational functions onto a single printed circuit board. Connecting the radios 16-20 to the SBC 14 allows a user or developer to change radios without any changes to most of the management software coding and management protocols. Furthermore, the SBC 14, as opposed to the routers or switches used in other such devices, provides more capability to manage, communicate with, and drive other devices than prior art wi-fi hotspots. Likewise, combination of the SBC 14 and the large case 12 allows for modularization. That is, the rest of the build does not need to change for modification of the DM device 10 due to the size of the case 12 and the modular capabilities built into each of the DM devices. An example SBC can be a Newport GW6300/6304 by GATEWORKS. However, other single board computers can be used without departing from the technology described herein.

In the embodiment illustrated in FIG. 4, the SBC 14 can include various standard features too, such as a processor (e.g., OcteonTX ARMv8 CPU, Dual 800 MHz), a power switch (e.g., a 5V power switch), a USB hub, USB dual type connectors, mini-PCIe sockets (which may couple the radios described herein with the processor and thus can include one, two, three, four, or more mini-PCIe sockets), GbE ports (e.g., RJ45 Jack 802.3at POE) and gigabit ethernet transceivers coupling the GbE ports with the processor. The SBC 14 can also include various memory (e.g., System DDR4 1-4 GBytes, eMMC Flash 4-64 GBytes, MicroSD socket for a MicroSD card, etc.). The USB hub can be communicably and/or electrically coupled with the mini-PCIe sockets, the USB dual type connectors, and the processor. Furthermore, the mini-PCIe sockets can couple to the processor via PCIe/SATA/USB3.0. The SBC 14 can also include various system control circuitry, such as real time clock control, temperature monitor, voltage monitor, Serial EEPROM, power control, switch monitor, and/or fan control. Such system control circuitry can be communicably coupled with a battery backup, a pushbutton switch (or other user-actuators for power off/on or other such user-controllable features), a tamper switch, and/or a fan or fan connector.

However, as noted above, various SBC functionality shown here can potentially be included on the SBC 14 but not utilized. The unutilized functionalities 28 can, for example, include various components as depicted in the embodiment in FIG. 4. Specifically, the unutilized functionalities 28 can include RS232/422/485 connectors and transceivers, digital IO connectors, SPI connectors, 12C connectors, signal conditioning components coupling the digital IO connector, the SPI connector, and/or the 12C connector to the processor, and optionally crypto security devices. Furthermore, the unutilized functionalities 28 in the embodiment in FIG. 4 labeled 50 can also include high efficiency power supplies, a barrel jack, a CAN bus standard on GW6304 and/or a CAN bus connector, a GPS receiver standard on GW6304, and an MMCX/UFL connector. However other standard SBC devices can be included on the SBC 14 and can remain utilized or unutilized for a given networking setup without departing from the scope of the technology described herein.

As noted above, the SBC 14 can be communicably coupled to one, two, three, four, or more radios or transceivers. For example, in some embodiments, the DM device 10 as depicted in FIGS. 1 and 4 has three radios 16-20, with at least one of the radios operating to send and/receive wireless signals in a first band of frequencies, and at least one of the radios operating to send and/receive wireless signals in a second band of frequencies. However, the DM device 10 can be configured to have up to four radios or more without departing from the scope of the technology described herein. One example embodiment of the DM device 10 is referred to herein as a RUCS Distribution Module Model 21 (model RDM21), as depicted in FIG. 4. For example, the RDM21 can be provided with three (3) 802.11a/b/g/n/s/ac/ax/be radio transceivers (Radio 0, Radio 1, and Radio 2) to send and receive Wi-Fi data. Radio 0 can operate in the 2.4 GHz bandwidth and function as the local access point for Wi-Fi enabled devices. Specifically, in some embodiments, Radio 0 can be a 3×3 MIMO 802.11ac (or alternatively 802.11ax or 802.11be) Mini PCIe Wi-Fi Module, Dual Band, 2.4 GHz/5 GHz QCA 9880 advanced edition with the 5 GHz band disabled by software. However, other such radio models and/or other Radio 0 frequencies can be used. For example, in some embodiments, instead of 2.4 GHz radios serving as the connecting radios of the DM devices, Radio 0 could instead be replaced with any radio allowed by the 802.11 IEEE specifications (e.g., 900 MHz, 5 GHz, 6 GHz, or the like), depending on different use cases to connect various devices. In various embodiments herein, Radio 0 can function as a local access point for Wi-Fi-enabled devices.

In some embodiments, the Radio 1 and/or Radio 2 communicate with one or more other DM devices in a mesh network arrangement. For example, Radios 1 and 2 can operate in the publicly accessible 5 GHz bandwidth range and provide the meshed backhaul between individual RDM21s (e.g., other DM devices) emplaced as part of a local network or system. Received RF signals can be amplified by high-gain antennae connected to each radio and mounted in conjunction with the DM device. In some example embodiments, Radios 1 and/or 2 can be 2×2 MIMO 802.11ac (or alternatively 802.11ax or 802.11be) Mini PCIe Wi-Fi Module, Dual Band, 2.4 GHz/5 GHz QCA 9880 advanced edition, with the 2.4 GHz band disabled by software. In other alternative embodiments, the Radios 1 and/or 2 can be replaced with 6 GHz radios. However, other such radio models and/or radio frequencies can be used for any of the radios without departing from the scope of the technology described herein, such as 900 MHz, 2.4 GHz, 5 GHz, 6 GHz, or other such radios allowed by 802.11 IEEE standards. For example, radios using one or more of the following standards can be used herein: 802.11a, 802.11b, 802.11g, 802.11n, 802.11s, 802.11ac, 802.11ax, 802.11be, or any other 802.11 IEEE standards known in the art. Radio modules or radios of the RDM21 can interact with the SBC via mini PCIe-mounted connectors or other such communication techniques known in the art. In some embodiments, for purely Wi-Fi transmittal and reception, there are no other peripheral devices or components required in the system. Similar to above, Radios 1 and/or 2 could be replaced with other frequency radio modules as system demands require. In some embodiments, a Radio 3 (not shown) can be optionally added without departing from the scope of the technology described herein.

All radio modules or radios of the RDM21 can operate using, for example, 802.11a/b/g/n/s/ac/ax/be IEEE standard for wireless communication or any other radios allowed by 802.11 IEEE standards. However, it will be appreciated that other communication bandwidths and/or additional IEEE standards or the like for radio communication bandwidths can be adopted and will likewise fall within the scope of the present invention. In some embodiments, Radio Modules DR6000VX and DR900VX can be used for the RDM21 and are electrically identical to each other regarding printed circuit board (PCB) design, components, and electromagnetic compatibility characteristics, with the only differences being the model names and the number of integrated antenna connections, as follows:

### Modular Radio 0 Information (DR900VX)

FCC ID: 2A2CS-RDM21
RF range is:
2412.0-2462.0 GHz per FCC Rule 15C
5180.0-5240.0 GHz per FCC Rule 15E
5745.0-5825.0 GHz per FCC Rule 15E
Note: 5 GHz bandwidths disabled by firmware in Radio 0

### Modular Radio 1 Information (DR600VX)

FCC ID: 2A2CS-RDM21
RF range is:
2412.0-2462.0 GHz per FCC Rule 15C
5180.0-5240.0 GHz per FCC Rule 15E
5745.0-5825.0 GHz per FCC Rule 15E
Note: 2.4 GHz bandwidths disabled by firmware in Radio 1

### Modular Radio 2 Information (DR600VX)

FCC ID: 2A2CS-RDM21
RF range is:
2412.0-2462.0 GHz per FCC Rule 15C
5180.0-5240.0 GHz per FCC Rule 15E
5745.0-5825.0 GHz per FCC Rule 15E
Note: 2.4 GHz bandwidths disabled by firmware in Radio 2

Note that the bandwidth ranges described herein (e.g., 2.4 GHz and 5 GHz, respectively) are interpreted herein to be “about 2.4 GHz” and “about 5 GHz” respectively. The term “about” in “about 2.4 GHz” is understood in the industry to mean running in a range of 2400 to 2483.5 MHz, where wifi systems typically operate. Likewise, the term “about” in “about 5 GHz” is understood in the industry to mean running in a range of 5.15 GHz to 5.85 GHz. That is, 5 GHz wireless communication can take place over a large spectrum with a number of non-overlapping channels of sizable bandwidth. In general, wi-fi coverage in the 2.4 GHz bandwidth can benefit from the lower frequencies more easily penetrating solid objects, such that wi-fi coverage is better carried throughout a building or home. However, in the 5 GHz bandwidth, the higher frequency may have a shorter range but can allow for faster wi-fi speeds. Likewise, similar industry standard frequency bandwidths for 900 MHz or 6 GHz radios are also known in the art, and the range covered by such frequency bandwidths is defined by 802.11 IEEE standards.

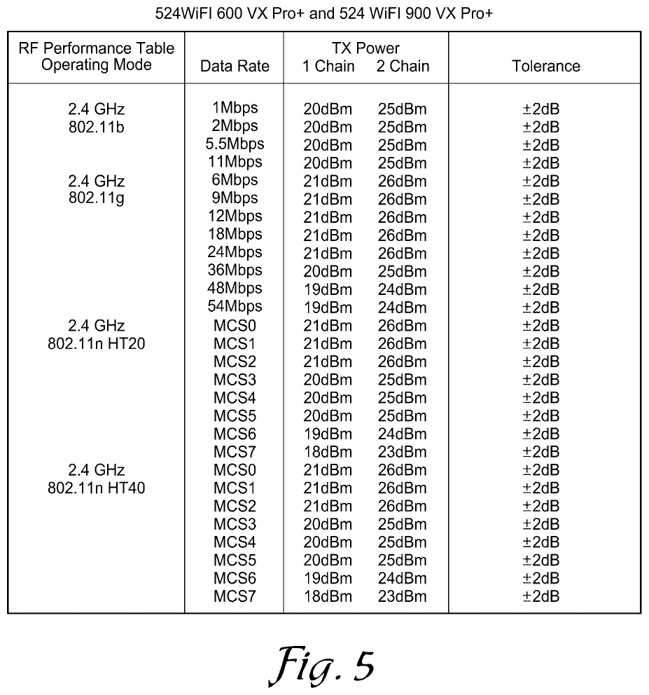

FIG. 5 depicts an example performance table associated with these exemplary radios described above (namely 524WiFi 600 VX Pro+ and 524WiFi 900 VX Pro+). Note that Remote Distribution Module RDM21 is merely one example of the technology described. In one embodiment, the RDM21 can include the following antennas for 2.4 GHz and 5 GHz signal distribution:
2.4 GHz Antenna: Three (3) ALFA AOA-2458-79AM omni antenna with 7 dB gain for 2400-2500 MHz
5 GHz Antenna: Two (2) ALFA APA-L2458M912 flat panel antenna with 12 dB gain for 5150-5850 MHz

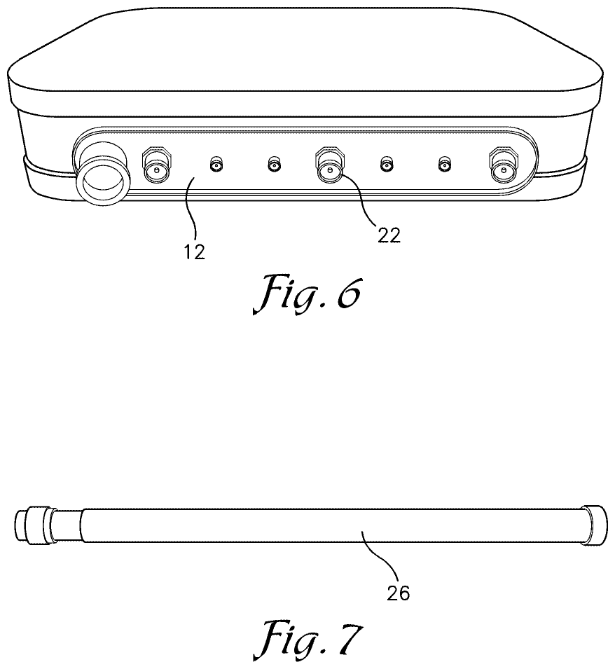

The plurality of input and output ports 22 and the various cables 24, as depicted in FIG. 1, are configured for electrical and/or communication signals to be delivered therein and/or for external connection to the internet or other such communications networks and systems. The ports can extend through a wall of the case 12 and/or be accessible through openings formed through a wall of the case 12. In some embodiments, as depicted in FIG. 6, the input and output ports 22 can include at least one Cat6 connection port extending outward from or accessible through the case 12, a plurality of 2.4-GHz radio connection ports for Radio 0 extending outward from or accessible through the case 12, and a plurality of 5-GHz radio connection ports for Radios 1 and 2, likewise extending outward from or accessible through the case 12. The Cat6 connection port can include or be connected to a passive PoE 8 W at 24V in one example embodiment, connecting the PoE injector 30 of FIG. 1, for example, to the SBC 14 or components thereof. In some examples of the DM device 10, as depicted in FIG. 1, cables such as RG174 can connect the 2.4-GHz radio connection ports. Furthermore, in some example embodiments, 1.13 mm, 50-ohm mini-coaxial cables can connect either of Radios 1 and/or 2 to one or more of the 5-GHz radio connection ports. However, other quantities and types of input and output ports 22 can be used for various quantities of radios possible, as described above. For example, an additional port can be included for a fourth radio (not shown) in an embodiment where the DM device 10 is configured to optionally include up to four radios.

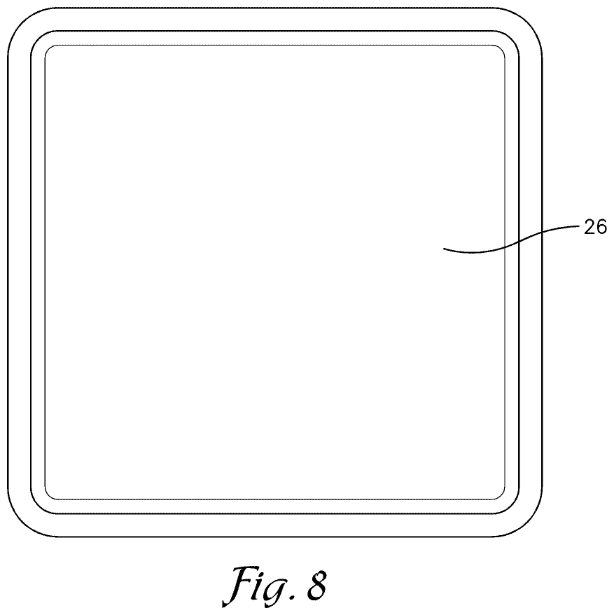

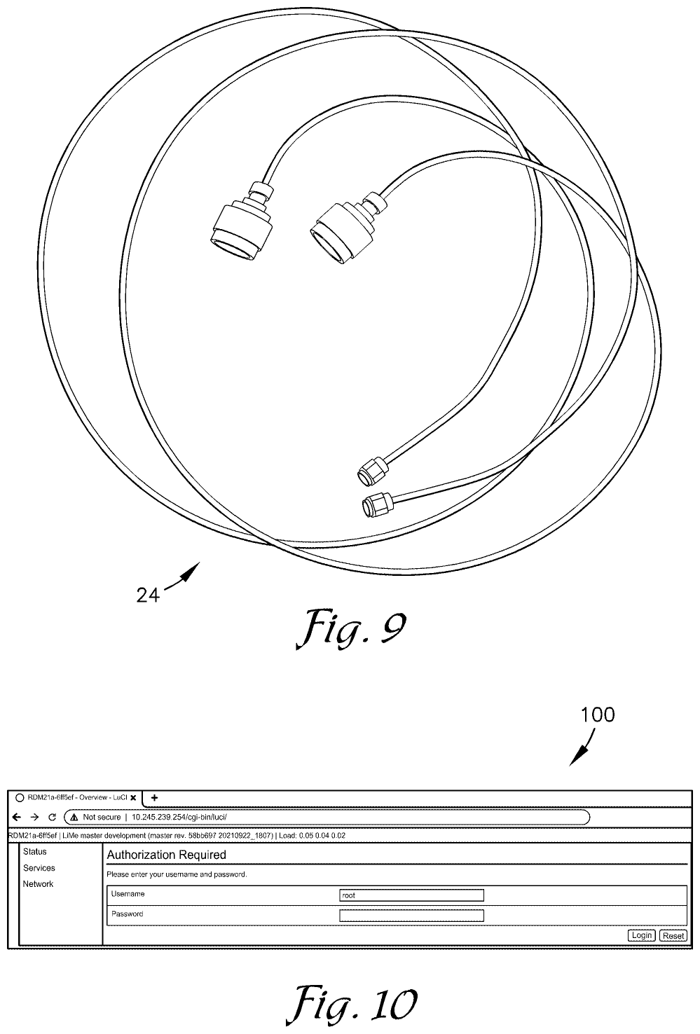

As depicted in FIG. 4 and further depicted in FIGS. 7 and 8, antennas 26 can be connected with the radios 16-20 via the ports 22 and can be at least partially located external of the case 12. For example, FIG. 7 depicts a 2.4 GHz omni antenna that can be connected to the 2.4-GHz radio connection ports for Radio 0. FIG. 8, on the other hand, depicts a 5-GHz flat panel antenna, and FIG. 9 depicts a 5-GHz flat panel antenna cables that can couple the 5-GHz radio connection ports for Radios 1 and 2 to the 5-GHz flat panel antennas. However, note that other comparable inlets, outlets, antennas, and other components equivalent to the exemplary components depicted herein can be used without departing from the scope of the technology described herein. For example, antennas for a fourth optional radio can also be included and/or one or more of the antennas can be replaced with antennas configured for 900 MHz, 6 GHz, or other frequency bands allowed by 802.11 IEEE standards.

In some embodiments, the DM device 10 and a plurality of devices identical thereto can be used as part of a turnkey, plug-and-play, secure, scalable, portable, and ruggedized IT network solution/secure network platform that can easily be deployed by non-technical personnel to support computers, VoIP handsets, laptops, printers, and Wi-Fi Cell phone connections to the internet or locally. For example, the secure network platform can use a next generation firewall and modern AI managed meshed field nodes such as the DM devices described herein, configurable to end-users' needs and specifications. The secure network platform can facilitate access to the internet and other communication networks through user selected satellite, wired, cellular and/or broadband radio connections. In some embodiments, the DM devices described herein can be used as part of the remote communications system and method described in patent application PCT/US2021/063554, filed Dec. 15, 2021, entitled REMOTE COMMUNICATIONS SYSTEM AND METHOD, incorporated by reference in its entirety herein. For example, the DM devices described herein can be used as the distribution modules 20 described in use with the systems and embodiments of the patent application PCT/US2021/063554. That is, a system for mesh networking communication in remote locations as described therein can include two or more of the DM devices described herein and a computing device 50 described below and depicted in FIG. 4.

Note that in embodiments where only a single DM device is required, the DM device 10 can merely use only one of its radios (e.g., the 2.4 GHz radio, Radio 0). However, the other radios (e.g., Radios 1 and 2) as described herein can be meshing radios for connecting to other devices with high signal capabilities and with high bandwidth. For example, Radio 1 may be wirelessly communicably coupled with a second DM device (e.g., Radio 1 or Radio 2 of a second DM device) and Radio 2 may be communicably coupled with a third DM device (e.g., Radio 1 or Radio 2 of a third DM device). In this example embodiment, the DM device 10 may be at a remote location relative to at least one of the second DM device and the third DM device. Using meshing, the DM devices can auto-connect and auto-tune to work cooperatively together, thereby building a cooperative mesh backbone automatically. For example, the SBC 14 and Radio 1 and/or Radio 2 may be configured to automatically connect and/or automatically tune to a second DM device to work cooperatively together therewith, automatically building a cooperative mesh backbone of networked DM devices.

In embodiments in which the DM device 10 is used as meshed field notes, the DM device 10 or multiple ones of the DM devices can be communicably coupled with the computing device 50, as depicted in FIG. 4. The computing device 50 can be communicably coupled with the DM devices via the internet or other wireless communication means. However, the DM device 10 can be communicably coupled and controlled by an external or remote computing device even in embodiments where only that one single DM device is required without departing from the scope of the technology described herein.

The computing device 50 can execute software or operational steps described herein. Such software, operational steps, or associated programs as described herein can be housed on and/or executed by the computing device 50. The computing device 50 can include one or more external computing devices and in some embodiments can include one or more processing elements of one or more of the DM devices, such as the SBC 14. In some embodiments, aspects of the computing device 50 may be implemented by and/or embodied by any one or more of the electronic devices shown schematically in FIG. 1 or 4. Additionally or alternatively, the computing device 50 can be embodied by one or more of computer servers, workstation computers, desktop computers, laptop computers, palmtop computers, notebook computers, tablets or tablet computers, smartphones, mobile phones, cellular phones, or the like. The computing device 50 broadly comprises at least one communication element, at least one memory element, and at least one processing element. Furthermore, in some embodiments, the computing device 50 includes or is communicably coupled with a display 52, as depicted in FIG. 4, which provides for user interaction and/or control of one or more of the DM devices.

The communication element of the computing device 50 generally allows the computing device 50 to communicate with the DM device 10 or DM devices, other computing devices, external systems, networks, and the like. The communication element may include signal and/or data transmitting and receiving circuits, such as antennas, amplifiers, filters, mixers, oscillators, digital signal processors (DSPs), and the like. The communication element may establish communication wirelessly by utilizing radio frequency (RF) signals and/or data that comply with communication standards such as cellular 2G, 3G, 4G, 6G, Voice over Internet Protocol (VoIP), LTE, Voice over LTE (VoLTE), or 5G, Institute of Electrical and Electronics Engineers (IEEE) 802.11 standard such as Wi-Fi, IEEE 802.16 standard such as WiMAX, Bluetooth™, or combinations thereof. In addition, the communication element may utilize communication standards such as ANT, ANT+, Bluetooth™ low energy (BLE), the industrial, scientific, and medical (ISM) band at 2.4 gigahertz (GHz), or the like. Alternatively, or in addition, the communication element may establish communication through connectors or couplers that receive metal conductor wires or cables which are compatible with networking technologies such as ethernet. In certain embodiments, the communication element may also couple with optical fiber cables. The communication element may be in electronic communication with the memory element and the processing element described below.

The memory element may be embodied by devices or components that store data in general, and digital or binary data in particular, and may include exemplary electronic hardware data storage devices or components such as read-only memory (ROM), programmable ROM (PROM), erasable programmable ROM (ePROM), random-access memory (RAM) such as static RAM (SRAM) or dynamic RAM (DRAM), cache memory, hard disks, optical disks, flash memory, thumb drives, universal serial bus (USB) drives, solid state memory, or the like, or combinations thereof. In some embodiments, the memory element may be embedded in, or packaged in the same package as, the processing element. The memory element may include, or may constitute, a non-transitory “computer-readable medium”. The memory element may store the instructions, code, code statements, code segments, software, firmware, programs, applications, apps, services, daemons, or the like that are executed by the processing element. The memory element may also store data that is received by the processing element or the device in which the processing element is implemented. The processing element may further store data or intermediate results generated during processing, calculations, and/or computations as well as data or final results after processing, calculations, and/or computations. In addition, the memory element may store settings, data, documents, sound files, photographs, movies, images, databases, and the like.

The processing element may comprise one or more processors. The processing element may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processing element may generally execute, process, or run instructions, code, code segments, code statements, software, firmware, programs, applications, apps, processes, services, daemons, or the like. The processing element may also include hardware components such as registers, finite-state machines, sequential and combinational logic, configurable logic blocks, and other electronic circuits that can perform the functions necessary for the operation of the current invention. In certain embodiments, the processing element may include multiple computational components and functional blocks that are packaged separately but function as a single unit. In some embodiments, the processing element may further include multiprocessor architectures, parallel processor architectures, processor clusters, and the like, which provide high performance computing. The processing element may be in electronic communication with the other electronic components through serial or parallel links that include universal busses, address busses, data busses, control lines, and the like. The processing element may be operable, configured, and/or programmed to perform the functions described herein by utilizing hardware, software, firmware, or combinations thereof.

The display 52 may be any display screen known in the art, such as a computer, laptop, or mobile communication device display screen. The display 52 can be operable to display various sensed and/or pre-programmed information regarding the DM devices, aspects of networking and/or meshing associated therewith, and other software aspects described herein. The display 52 can be a touch-screen display and/or can be controlled via user input devices such as a mouse, a mouse pad, a keyboard, a stylus, or other such display and/or cursor control means known in the art.

The software or software program stored on and/or executable by the computing device 50 is configured to help manage the DM devices more efficiently than prior art software. The software program serves as part of a universal management system and embraces multiple radio sets, so users and developers do not have to change software each time adjustments are made to the DM devices. In some embodiments, open wireless radio transmission (OpenWRT) is used in conjunction with other open-source software (such as OpenWSP and OpenNDS) to provide a management software platform for the DM devices. OpenWRT was made to build large volume mesh-to-network systems that are remotely managed. The software program described herein may be an overwatching management software program that monitors the function of each one of a plurality of the DM devices meshed together. In some embodiments, LibreMesh software is a wireless radio transmission software that is utilized by the software and hardware described herein. OpenWRT/LibreMesh software is an open-source software customizable with lots of packets that can be combined into the management software to perform the functions described herein. The overwatch management software allows a user to manage a plurality of DM devices meshed together and make adjustments to various radios, for example, from a computer or other electronic device that is remote to the DM device 10, such as via the Internet 36 in FIG. 4.

To manage and operate the installed distribution modules (e.g., DM device 10), an overwatch program can work with the NMS software that is native to the OperWrt/LibreMesh operating system. This overwatch software can also be configured to provide automatic reporting, trouble alerts, and notification to the system owners, operators, and managers for any number of individual clients and operating systems that are deployed using the DM devices. For example, such alerts and notifications can be provided to a user of the computing device via the display 52 described above and/or can be sent to another remote user device or display communicably coupled with the computing device. In addition, the overwatch system may provide the display 52 or another remote interface with information or user-selectable menu options for updating any or all field-located DM devices with firmware updates, security software updates, and the like to ensure the operation and security of the installed DM devices and systems. Specifically, the overwatch software program may instruct the computing device to provide at least one of firmware updates, security software updates, and other software management activities to the SBC 14 for operation and security of the DM device 10.

FIGS. 10-18 provide exemplary screen captures of a management software interface associated with the DM device 10 or DM devices (e.g., RDM21). In some embodiments, such a management software interface may be displayed on the display 52. Various windows and user-selectable features displayed thereon can operate as described in the following example embodiments and can perform some of the functionalities described herein. However, the precise design and manner in which the user-selectable features are displayed can be modified without departing from the scope of the technology described herein.

In one example embodiment, to access Radio Module settings on the DM device 10, an operator or user can first connect the supplied Power over Ethernet (POE) connector to a 120 v power outlet, and connect an ethernet (cat5/cat6) cable from a ‘Gigabit POE’ port to the RJ45 port (as depicted on the RDM21 block diagram in FIG. 4). Next, the operator can wait a few minutes for the modem/router 32 to boot up, then connect a user computer (e.g., the computing device 50) to either the Wi-fi or connect an ethernet cable from the user computer to the ‘Gigabit LAN’ port on a PoE connector. After that, the operator can open a web browser via the computing device 50 and enter a web address for accessing the management software interface to be presented on the display 52.

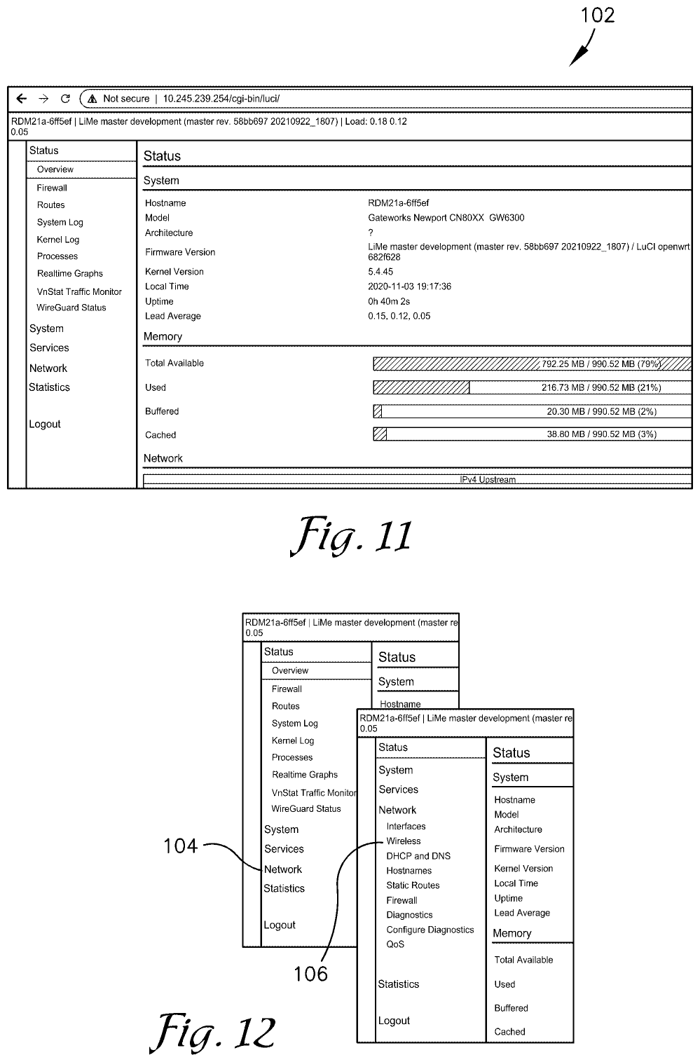

In some example embodiments, the management software interface can display a login screen 100 as depicted in FIG. 10, requiring a username and password. Once the username and password are entered, a screen as depicted in FIG. 11 can appear, presenting an Overview screen 102 with system information, memory information, and other selectable menu options available via the management software interface. For example, selecting the status menu option (as depicted on the lefthand side of FIG. 11) can allow access to the depicted Overview screen, or alternatively the operator can select one of the other links (e.g., user-selectable text) related to the following category statuses: firewall, routes, system log, kernel log, processes, realtime graphs, VnStat traffic monitor, WireGuard Status, or any other related statuses monitored by or within the DM device 10. Other selectable menu options can include options related to the system, services, network, statistics, or logging out.

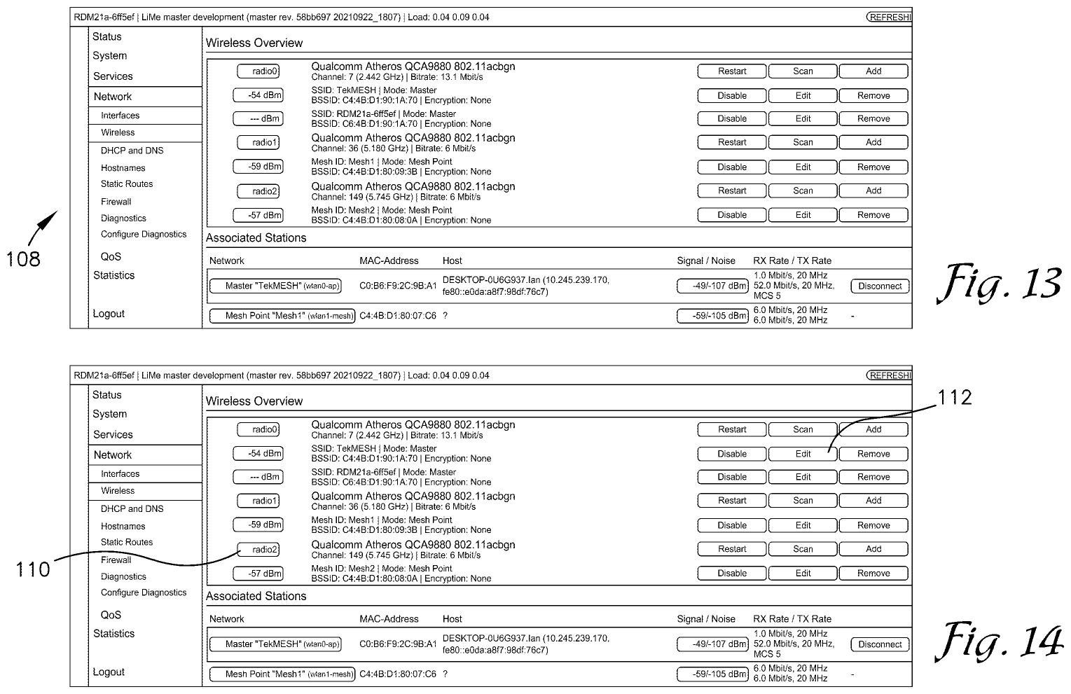

Once logged in, the operator can navigate to the radio settings that need to be modified. To access the radio settings, the user can, for example, select the selectable menu option “Network” 104, and then select “Wireless” 106 from additional option items that have appeared upon selecting “Network” 104, as depicted in FIG. 12. This selection can present a screen that displays a wireless overview 108 and associated stations, as depicted in FIG. 13. For example, icons 110 for Radio 0, Radio 1, and Radio 2 can be displayed. As described above, Radio 0 can be a 2.4 GHz or local Wi-Fi access radio (e.g., model 2A2CS-RDM21), Radio 1 can be a 5 GHz mesh radio (e.g., model 2A2CS-RDM21), and Radio 2 can be a 5 GHz mesh radio (e.g., model 2A2CS-RDM21). FIG. 13 depicts an annotated version of the screenshot of FIG. 13, identifying the “edit” button 112 that can be selected to edit Radio 0 in one example embodiment.

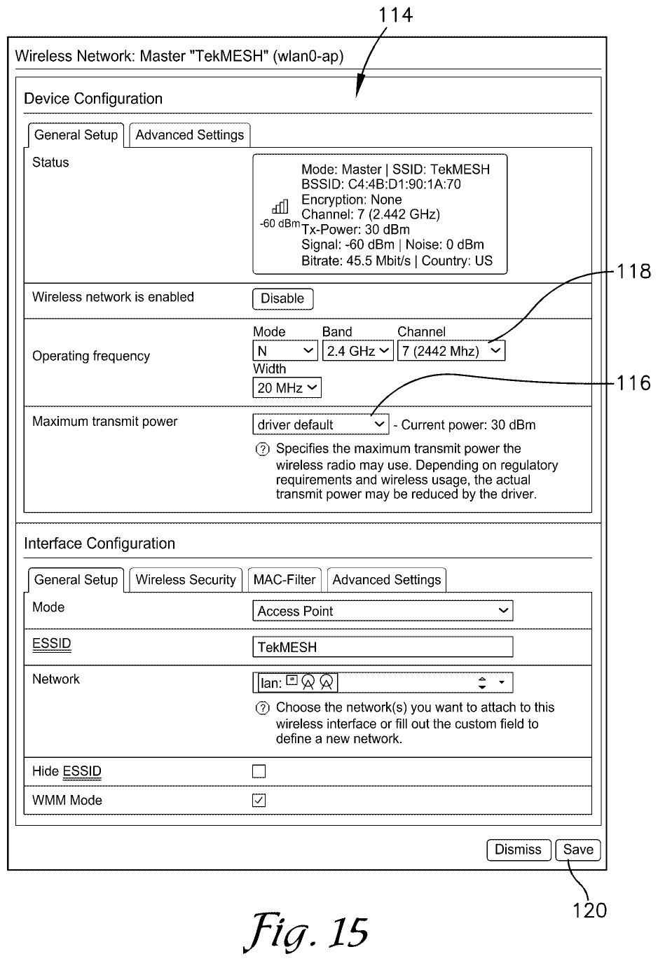

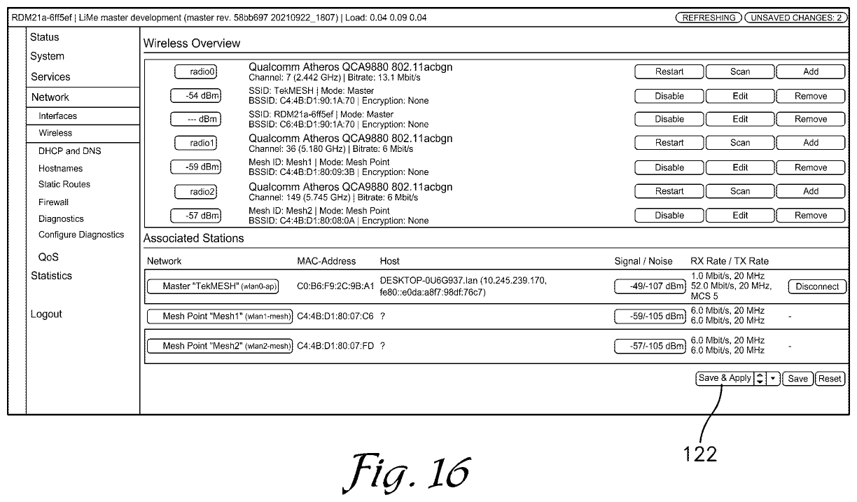

In some embodiments, as depicted in FIG. 15, when Radio 0 editing is selected, another screen or a pop-up screen 114 displays a Device Configuration and Interface Configuration for that Radio 0. In order to change the Transmit Power via this screen depicted in FIG. 15, the operator can click a dropdown menu 116 shown as ‘driver default’ and select what the user requires. The range in this example embodiment is 0 dBm (1 mW) to 30 dBm (1000 mW.) In order to change the Channel, the operator can click the dropdown menu 118 shown as ‘7 (2442 Mhz)’ and select what the user requires. The range in this example embodiment is 1 (2412 Mhz) to 13 (2472 Mhz) with an additional ‘auto’ function that can be selected in order for the software itself to select the channel based on predetermined rules. Once editing of Radio 0 is complete, a green ‘save’ option 120 can be selected by the operator to save those Radio 0 changes. However, the save option can be provided in any color or style without departing from the scope of the technology herein. At this point, the pop-up screen 114 can automatically close or be closed by the user and then a ‘Save & Apply’ button 122 can be selected in the screen depicted in FIG. 16.

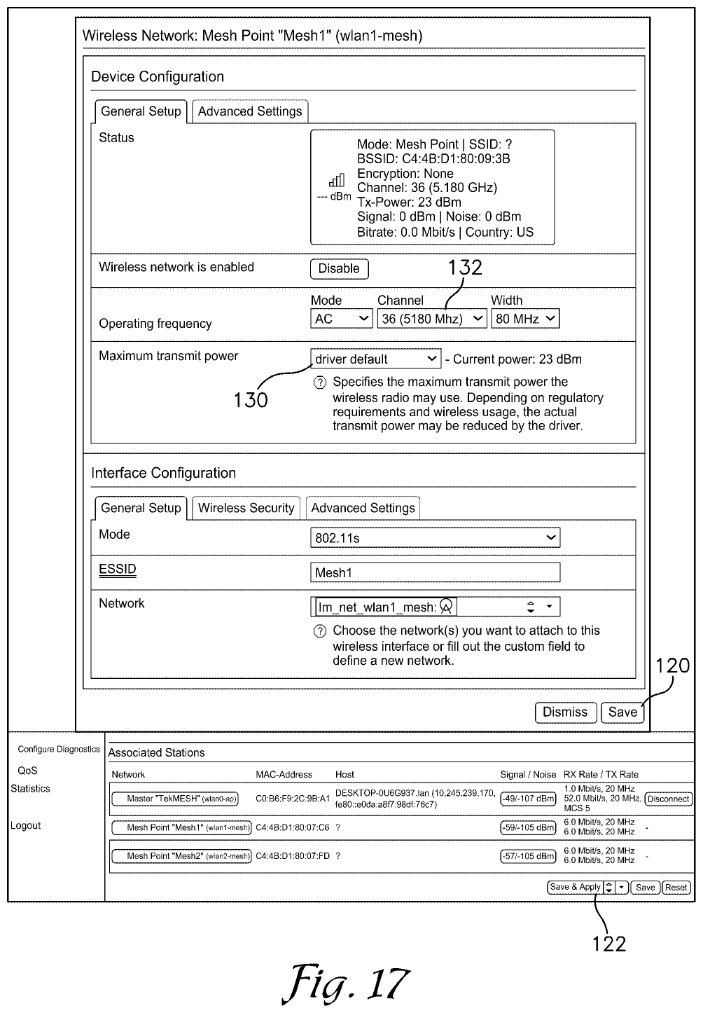

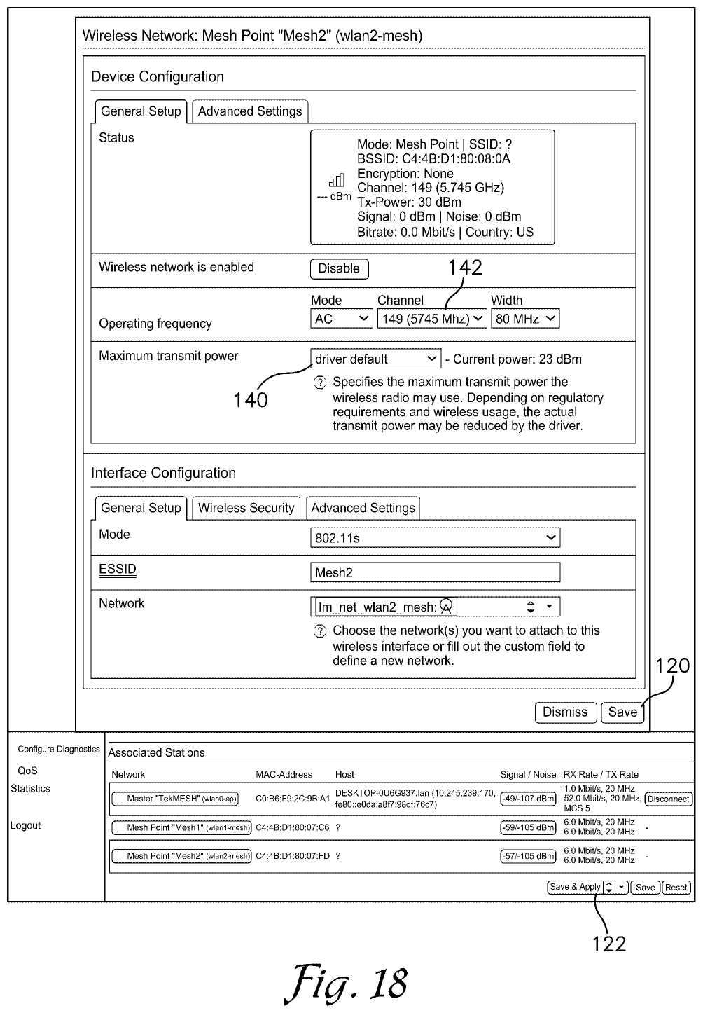

Similarly, Radio 1 and Radio 2 can also be edited, as depicted in FIGS. 17-18, with FIG. 17 for Radio 1 labeled “Mesh 1” and FIG. 18 for Radio 2 labeled “Mesh 2.” For example, for Radio 1 as depicted in FIG. 17, drop-down menu options 130 for ‘Maximum transmit power’ may also include ‘driver default’, with a range of 0 dBm (1 mW) to 30 dBm (1000 mW) and for a drop-down menu labeled ‘Operating frequency,’ ‘Channel’ drop down menu options 132 for Radio 1 can start as 36 (5180 Mhz) with a range of 36 (5180 Mhz) to 165 (5825 Mhz). For Radio 1, the default can be channel 36 at 80 MHz channel width, although any other defaults can be operator without departing from the scope of the technology herein. For example, these channel options can span channels 36 (5180 Mhz) to 44 (5220 Mhz).

In another example embodiment as depicted in FIG. 18, if Radio 2 is selected for editing, another popup may appear that shows ‘Device Configuration.’ Drop-down menu options 140 for ‘Maximum transmit power’ can include a ‘driver default’ option, with a range of 0 dBm (1 mW) to 30 dBm (1000 mW) and for the drop-down menu options labeled ‘Operating frequency,’ ‘Channel’ drop-down menu options 142 can start as 149 (5745 Mhz) with a range of 36 (5180 Mhz) to 165 (5825 Mhz). For Radio 2, the default can be channel 149 at 80 MHz Channel Width, although other defaults can be used without departing from the scope of the technology herein. For example, these can span channels 149 (5745 Mhz) to 157 (5785 Mhz). Once modifications have been made, the operator can again click the green ‘Save’ option 120, then the blue ‘Save & Apply’ button 122 (or other such links that perform these functions, regardless of identifying color, text, or features used).

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claim(s) at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the disclosure, what is claimed as new and desired to be protected by Letters Patent includes the following:

1. A distribution module (DM) device comprising:
a rigid case having a hollow interior;
a single-board computer (SBC) mounted within the rigid case;
a first radio configured to serve as an internet access point and communicably coupled within the rigid case to the SBC; and
one or more other radios with meshing capabilities and communicably coupled within the rigid case to the SBC.

2. The DM device of claim 1, wherein at least the first radio is configured to send and receive wireless signals in a first band of frequencies, and at least one of the one or more other radios is configured to send and receive wireless signals in a second band of frequencies that is different than the first band of frequencies.

3. The DM device of claim 2, wherein the first radio operates at about a 900 MHz bandwidth, about a 2.4 GHz bandwidth, about a 5 GHz bandwidth, or a about a 6 GHz bandwidth and functions as a local access point for Wi-Fi-enabled devices.

4. The DM device of claim 2, wherein at least one of the one or more other radios operates about a 900 MHz bandwidth, about a 2.4 GHz bandwidth, about a 5 GHz bandwidth, or a about a 6 GHz bandwidth.

5. The DM device of claim 2, wherein the one or more other radios comprise a second radio with meshing capabilities and communicably coupled within the rigid case to the SBC, and a third radio with meshing capabilities and communicably coupled within the rigid case to the SBC, wherein the second radio and the third radio both operate at about a 5 GHz bandwidth.

6. The DM device of claim 5, wherein the second radio and the third radio communicate with one or more other DM devices in a mesh network arrangement.

7. The DM device of claim 5, wherein the SBC and at least one of the second radio and the third radio are configured to at least one of automatically connect and automatically tune to a second DM device to work cooperatively together, automatically building a cooperative mesh backbone of networked DM devices.

8. The DM device of claim 5, wherein the second radio is wirelessly communicably coupled with a second DM device and the third radio is communicably coupled with a third DM device, wherein the DM device is at a remote location relative to at least one of the second DM device and the third DM device.

9. The DM device of claim 1, wherein the hollow interior of the rigid case is at least twice the volume or twice the area occupied by the SBC, the first radio, and the one or more other radios.

10. The DM device of claim 1, controlled by a computing device communicably coupled with the SBC, the computing device having an overwatch software program operating thereon, wherein the overwatch software is configured to provide automatic reporting, trouble alerts, and notifications regarding the DM device to a user of the computing device or a display communicably coupled with the computing device.

11. The DM device of claim 10, wherein the overwatch software program instructs the computing device to provide at least one of firmware updates, security software updates, and other software management activities to the SBC for operation and security of the DM device.

12. The DM device of claim 10, wherein the overwatch software is configured to instruct the display communicably coupled with the computing device to display user-selectable options for updating of the DM device.

13. A system for mesh networking communication in remote locations, the system comprising:
two or more distribution module (DM) devices each comprising:
a rigid case having a hollow interior,
a single-board computer (SBC) mounted within the rigid case,
a first radio configured to serve as an internet access point and communicably coupled within the rigid case to the SBC,
a second radio with meshing capabilities and communicably coupled within the rigid case to the SBC,
a third radio with meshing capabilities and communicably coupled within the rigid case to the SBC, wherein the second and third radios each operate at a higher bandwidth than the first radio; and
a computing device communicably coupled with the two or more DM devices, wherein the computing device has a computer program operating thereon, wherein the computer program is configured for management of the SBC of any of the two or more DM devices.

14. The system of claim 13, wherein the first radio operates at about a 2.4 GHz bandwidth and functions as a local access point for Wi-Fi-enabled devices.

15. The system of claim 13, wherein the second radio and the third radio each operates at about a 5 GHz bandwidth.

16. The system of claim 13, wherein the computer program is an overwatch software program, wherein the overwatch software program is configured to provide automatic reporting, trouble alerts, and notifications regarding at least one of the two or more DM devices to a user of the computing device or a display communicably coupled with the computing device.

17. The system of claim 16, wherein the overwatch software program instructs the computing device to provide at least one of firmware updates, security software updates, and other software management commands to the SBC of at least one of the two or more DM devices for operation and security thereof.

18. A distribution module (DM) device comprising:
a rigid case having a hollow interior;
a single-board computer (SBC) mounted within the rigid case;
a first radio configured to serve as an internet access point and communicably coupled within the rigid case to the SBC;
a second radio with meshing capabilities and communicably coupled within the rigid case to the SBC;
a third radio with meshing capabilities and communicably coupled within the rigid case to the SBC, wherein the second and third radios each operate at a higher bandwidth than the first radio; and
a plurality of ports extending through the rigid case and at least one of electrically and communicatively coupled with one or more of the SBC, the first radio, the second radio, and the third radio; and
a plurality of external antennae each coupled to at least one of the plurality of ports.

19. The DM device of claim 18, wherein one of the plurality of ports is coupled to a Power over Ethernet (PoE) injector.

20. The DM device of claim 18, wherein the first radio operates at about a 2.4 GHz bandwidth and the second and third radios each operates at about a 5 GHz bandwidth.
